(19) United States
(12) Patent Application Publication
(10) Pub. No.: US 2005/0182856 A1
(43) Pub. Date: Aug. 18, 2005

(54) Systems and methods for creating time aware networks using independent absolute time values in network devices

(76) Inventor: Charles Lee McKnett, Rancho Santa Fe, CA (US)

Correspondence Address: PAUL, HASTINGS, JANOFSKY & WALKER LLP, P.O. BOX 919092, SAN DIEGO, CA, 92191-9092, US

(21) Appl. No.: 10/745,187

(22) Filed: Dec. 22, 2003

(51) Int. Cl. G06F 15/16; G06F 15/173

(52) U.S. Cl. 709/248; 709/225

(57) ABSTRACT

A time aware network having an inherent time reference that enables the sharing of network resources in a network environment wherein the transfer of synchronized time information is not required is provided. The internal time reference is established using absolute time values which are time coordinates extracted from a GPS signal. The absolute time values and a defined clock parameter block, coordinate how the time-aware devices use the internal time reference and are further used to establish a network domain. Devices capable of meeting the network clock domain timing requirements may participate in the domain. Upon joining a network clock domain, a client may access a shared resource through a locking authority which maintains the data coherency of the shared resource. The client, locking authority and shared resource are all time aware devices participating in the same network clock domain communicating using the internal time reference.

### BACKGROUND OF THE INVENTION

1. Field of the Invention

The invention relates generally to computer networks and more particularly to creating an inherent network time reference that enables the sharing network resources in a distributed network environment wherein the transfer of synchronized time information is not required.

2. Background

To date, computer networks are unable to implement the complex communication and resource sharing capability typically realized in a stand alone computer system. Two areas that present specific problems for computer networks include the unsolved clock distribution problem and the inability to maintain data coherency among shared resources. At one point, these same areas which present major problems for computer network designers also presented problems for computer designers. However, solutions to these problems with respect to computers were developed decades ago. Unfortunately, the solutions that worked for computers have not succeeded when implement at the network scale.

a. The Clock Distribution Problem

The need for a centralized and common time base in any computer system is undeniable. Clock distribution is essential to computer design because all subsystems and components must see the same clock signal in order to function properly. This is true for both the stand alone computers and for computer networks. Clocks dictate a high level of coordination between all of the subsystems and components. As such, the all component must be synchronized with the computer clock in order to operate.

Conventional computer networks attempt to resolve the clock distribution problem by introducing timing to networks using a time server to coordinate and synchronize time between computer on the network. However, because networks inherently fall victim to latency problems, time servers fail to provide an accurate and precise time reference upon which all components in a computer network can rely.

Data transmission on a computer network employs self-clocking waveforms. While this allows accurate reconstruction of the transmitted signal at the receiver, there is no way of determining information about the transmit clock's timing of phase, phase shift or delay in transmission across the network. Latency therefore becomes an unknown quantity. Without some knowledge of latency, it is impossible to provide a precise time reference across a computer network. As such, most solutions to the network clock distribution problem are inherently limited by the bandwidth and latency problems associated with transferring the time to each client and resource across the network. Thus, any solution that ultimately requires “time synchronization” or “time coordination” is doomed to fail as a result of the limitations inherent in a network.

b. Resource Sharing

Computers employing multiple CPU systems are capable of sharing I/O resources and memory resources by allowing each CPU exclusive and controlled access to the selected resources. This exclusive access is referred to as a lock. The locking process ensures that, during the time a CPU has access to a shared resource, the resource's data will not be changed by any other CPU other than the CPU having exclusive access to or a lock on the resource. Granting exclusive access via the locking concept ensures the data coherency of the shared resource.

To date, attempts to employ the concept of resource sharing on the network scale have failed. Specifically, attempts that allow a CPU in one network computer to share resources and subsystems located on another network computer have proven unsuccessful for numerous reasons. These reasons highlight the differences between a network environment and the environment of a single computer. For example, networks tend to be unreliable in terms of data delivery, unable to detect a high rate of data transmission errors, and unable to correct data transmission failure. Such deficiencies make it difficult to ensure data coherency when sharing resources. Furthermore, unlike computers, which operate synchronously, computer networks operate in an asynchronous fashion. Therefore, designers of subsystems, components and software cannot make assumptions concerning the sequence or order of messages transmitted from other network components. Furthermore, a network's inability to prioritize the order of received message hampers its capability to correctly establish, grant and release locks to resources shared on the network.

The lack of precise time synchronization for computer networks has forced computer networks to share resources using complex handshakes. Handshakes provide a minimal form of restricted or unrestricted access to a shared resource for one client while notifying the other clients as to the state of the shared resource (i.e. either being locked or unlocked). All clients, however, must concur when access to the shared resource is granted. The handshaking technique is inherently weak because if communication with any client is lost or delayed, access to the shared network resource is denied to all clients. As such, although sharing resources at the computer level has proven invaluable, the differences between computers and computer networks have hampered the network scale implementation of sharing-resources while maintaining data coherency.

Ultimately, networks should perform in a manner equivalent to the capabilities currently realized by the stand alone computer. Therefore, a system and method is need that will eliminate the network clock distribution problem thus enabling effective sharing of computer resources between numerous clients while maintaining data coherency among the shared resources. The present invention, as described in detail below, solves this problem by presenting a method for establishing an inherent network time reference and further presenting a system for sharing network resources that does not require the transfer of time information.

### SUMMARY OF THE INVENTION

In order to combat the above problems, the systems and methods described herein provide an inherent network time reference for time aware devices that eliminates the need to transfer synchronized time information between the time aware device in order to communicate. More specifically, the inherent network time reference is created when an absolute time value, associated with a time aware device, satisfies defined timing requirements. Specifically, the time aware device obtains an absolute time value by extracting a time coordinate from a received GPS signal. If the absolute time value satisfies defined timing requirements set forth in a parameter block, a synthetic or pseudo network clock is established which makes the time aware devices capable of interacting as if having a common clock generated and distributed among them.

In another embodiment of the invention, the system and methods described herein also provide for a time aware network. Specifically, a time aware network uses absolute time values associated with each time aware device to create a time reference equivalent to a computer clock. The time aware devices that constitute a basic time aware network include, but are not limited to, a client, a router, a locking authority and a shared resource. The locking authority is responsible for creating and maintaining a network clock domain, which provides controlled locking services between the client and the shared resource. Specifically, the locking authority creates the network time domain using a clock parameter block. Together, the clock parameter block and the absolute time values are used to generate a pseudo-clock. The clock parameter block defines timing requirements and precise values for the absolute time values that the client must guarantee in order to participate. Once the client joins the network clock domain, the client uses the pseudo-clock to communicate with other time aware devices in the domain. Specifically, the client requests access to the shared resource and the locking authority grants an exclusive lock to the client based on transmission based time stamps.

In yet another embodiment, a method for controlling shared resources in a scale free network, while ensuring the integrity and coherency of the data associated with the shared resource is provided.

In another embodiment, a method for sequencing, ordering and sorting incoming packets based on a transmission time based time stamp is provided. Similarly, method for using absolute time values to sequence and order received packets is provided. A system and method for creating transmit time stamps using an absolute time value is also provided.

In yet another embodiment, a system and method for implementing a robust network for accessing, locking and sharing a network resource among numerous devices is provided.

In still another embodiment, a method for establishing network clock domains using an absolute time value associated with time aware devices is provided.

### BRIEF DESCRIPTION OF THE DRAWINGS

Preferred embodiments of the present inventions taught herein are illustrated by way of example, and not by way of limitation, in the figures of the accompanying drawings, in which:

FIG. 1 is a basic time aware network used in accordance with the present invention;

FIG. 2 is a time aware network employing three individual network clock domains to provide synchronized access to at least three network resources;

FIG. 3 is a flow chart depicting the process taken by the locking authority to initialize a network clock domain;

FIGS. 4 and 4a are both flowcharts illustrating the process of a client joining the network clock domain;

FIG. 5 is a flowchart illustrating the enumeration and verification process performed upon the locking authority's identification of an attached network resource;

FIG. 6 is a flow chart illustrating the process for determining the transaction capabilities of a network resource identified in the enumeration process described in FIG. 5;

FIG. 7 is a timing diagram that illustrates the generation of a pseudo-clock using network clock domain parameters and absolute time values;

FIG. 8 is a block diagram that illustrates the logical structure of the locking authority;

FIG. 9 is a diagram illustrating a basic out of order reject locking scenario;

FIG. 10 is a diagram illustrating a locking scenario wherein the locking authority reorders lock requests and transactions when a request is received out of order;

FIG. 11 is a diagram illustrating how a locking authority can reorder requests received out of order when a client is capable of unwinding a transaction already in progress; and

FIG. 12 is a diagram depicting a locking scenario wherein a client's unwind request is rejected.

### DETAILED DESCRIPTION OF THE PREFERRED EMBODIMENTS

In the descriptions of example embodiments that follow, implementation differences, or unique concerns, relating to different types of systems will be pointed out to the extent possible. But it should be understood that the systems and methods described herein are applicable to any type of network system.

I. Absolute Time Base

The Global Positioning System (“GPS”) is a vast network of satellites readily used for navigational purposes. GPS is typically described as being based on triangulation or the concept of three-dimensional space. However, GPS actually triangulates in four dimensions. As such, a GPS enabled device learns of its location using four coordinates, namely a longitude coordinate, a latitude coordinate, an altitude coordinate and a time coordinate. Because each GPS receiver computes its navigational location using a time coordinate, GPS inherently creates an absolute time value that is available for all devices anywhere on Earth.

Advantageously, the inherent time reference actualized by GPS signals essentially solves the intractable network clock distribution problem. Moreover, GPS solves this problem by ignoring its very existence. Instead of focusing on clock distribution and time synchronization, GPS may be used to define a class of time aware devices. Each time aware device contains its own GPS receiver and time decoding circuit used to extract a time coordinate from a received GPS signal. Since each time aware device has its own internal time value derived from the GPS receiver, there is no need to establish a common time base. Essentially, the GPS system already provides the required time platform. As such, an absolute time value is established when the time aware device creates its own “pseudo-clock” by extracting a time coordinate from the received GPS signal. The absolute time value eliminates the conventional need for a central clock or time-server.

Time aware devices are nevertheless capable of interacting as if having a common clock generated and distributed among them. To communicate without transferring and synchronizing time information, the individual time aware devices adhere to an established protocol regarding the use of their internally generated “pseudo-clocks.” As is described in detail below, a time aware network, in conjunction with a network clock domain, is used to coordinate how the time-aware devices use their internally generated “pseudo-clocks” to interact with other time aware devices and to access shared network resource.

II. The Time Aware Device

Generally, a time-aware device may be any device that includes a GPS receiver. Logic may optionally be used in determining a time coordinate based on position information. These elements, of course, are non-limiting, thus any hardware or software method may be used in extracting the time coordinate from the GPS signal. Various manufacturers make devices for extracting precise time coordinates from the GPS signals. As such, the techniques for extracting precise time from GPS signals are known to one skilled in the art. Therefore, any one of these techniques may be used to obtain the time coordinate. Additionally, it is also possible for portions of the GPS receiver, such as the antenna and RF sections to be located external to the device or even shared among several devices located within the error range normally associated with the GPS system.

With respect to the time aware devices, it is important to emphasize that each device is completely independent and is not required to coordinate or synchronize with other devices to establish a common time reference. Each time aware device is capable of keeping time, based on an extracted GPS signal coordinate, with a known worst case accuracy and a derived current time accuracy that is based on signal integrity, error measurements and device capabilities.

Alternatively, time aware devices may be constructed having a specialized bus interface that enables the devise to obtain the GPS signal with an accurate and known delay. The precise timing coordinate may be extracted from the GPS signal received over the bus using an algorithmic adjustment to compensate for the delay. The bus may be a broadcast bus or a request-response system. More specifically, the bus provides a method for combining several time aware devices into a single device. This may be accomplished with several interface cards plugged into a common chassis. In this case, a GPS receiver would supply the bus with the absolute time value for each interface card connected to the bus. Preferably, the electrical and timing characteristics of the bus should be tightly controlled. In addition, the device may be located in close physical proximity. Furthermore, the devices should also be collocated in a device such as a computer or router chassis that already has an internal time base such as a computer clock so that the bus could be completely synchronous. Alternatively, a group of devices may share a single GPS receiver in order to lower cost and space requirements.

III. The Time Aware Network

Because GPS provides a means of obtaining an absolute time value, there is no need to synchronize or coordinate time between various computer and network peripherals. The establishment of this absolute time base allows the time aware devices to share resources while maintaining the integrity of the shared resources. This is accomplished using a time aware network.

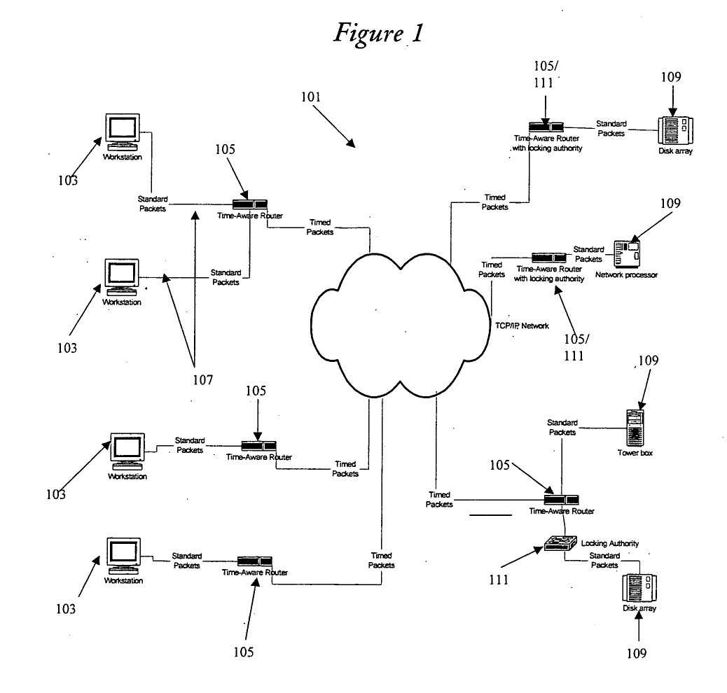

FIG. 1 depicts a basic time aware network 101 in accordance with the present invention. Specifically, the time aware network 101 consists of time aware devices, including but not limited to, a client 103, a resource 109, a time aware router 105 and a time aware locking authority 111 as described below.

a. Clients:

A client 103 is a time aware device capable of communicating with other time aware devices in the time aware network 101. Exemplary and non-limiting embodiments of a client 103 include workstations, servers, central processing units, and any wireless device. Furthermore, because time aware networks are independent of the actual type of network transport used, devices using satellite transmission may also constitute a client. Software drivers are loaded on the clients 103 enabling the client 103 to communicate with other time aware devices including the time-aware routers 105 as depicted in FIG. 1. Clients 103 are attached to the time aware routers 105 through a standard network transport 107 as described below.

b. Network Transport:

As depicted in FIG. 1, the client 103 is attached to the time aware router 105 via a network transport 107. The network transport itself may be any type of network transport. For example, the network transport 107 may be a transport standard that encompasses both physical and logical transport layers, such as a fibre channel network. Alternatively, the network transport 107 may be a TCP/IP network transport, including a logical layer (TCP/IP) supported by various physical transport layers including but not limited to Ethernet and ATM physical network topologies.

In short, any data transmission network may serve as a transport for the time stamped data passed between time aware devices. This transport also includes networks utilizing satellite transmission for connection. As such, the methods and techniques described herein are independent of the transmission media thus allowing any network transport to be used including wireless, wired or fiber optic.

c. Time Aware Router:

As shown, a packet transmitted on the network transport 107 from client 103 is routed through the time aware router 105. Packets transmitted through the time aware router 105 are time stamped with the absolute time value derived from a GPS signal by the time aware client 103 as described above. Unlike conventional routers, the time aware routers 105 do not communicate, synchronize or exchange time information among the connected devices. Rather, the time aware routers 105 rely on the absolute time value locally available within each time aware client device 103. Alternatively, because each time aware router 105 has a GPS receiver, the time aware router 105 may stamp transmitted packet using its own absolute time value.

More specifically, the time stamps used by the time aware router 105 are associated with the point in time that the packet is transmitted from the client 103. Using a time value based on transmission time of the time stamp allows time aware routers 105 and receivers to determine the sequence or order based on time of transmission rather than the time of reception. This is a crucial element for maintaining data coherency in shared network resources.

The time-aware routers 105 accept standard network packets and append time stamps to the packets in such a manner as not to affect the routing of the packets over the network transport. Packet time stamping may be implemented at the physical layer level or at a higher network protocol level.

1.) Network Layer Time Stamping

Time stamping may be accomplished by expanding either the TCP layer header or the IP layer header beyond the standard 20 bytes to accommodate the time stamp. Depending on the network configuration, the time stamp may be inserted at the IP layer so as not to affect the transmission of packets using TCP (Transmission Control Protocol), ICMP (Internet Control Message Protocol), UDP (User Datagram Protocol) or other packet protocols.

Of course, inserting the time stamps at the TCP layer still allows the use of upper layer protocols such as HTTP (Hypertext Transfer Protocol), FTP (File Transfer Protocol), Telnet, etc. However, inserting time stamps at the TCP layer only allows participation by specified TCP ports in the time aware network, thus leaving other ports without the time aware features. Of course, system administrators may configure networks to provide time stamps and time aware features according to individual needs. For time-aware packets and networks implemented over the Internet, time stamps are inserted at the IP layer thus enabling the participation of all TCP ports.

2.) Physical Layer Time Stamping

In some cases, Media Access Control (MAC) layer headers may be configured to accept time stamps. Time stamped MAC layer headers may be utilized with fibre channel networks having optional network headers. The MAC layer header may be configured to hold time stamps for each frame or sequence, depending on network configuration.

With respect to Ethernet MAC headers, sideband modulation may be used on the bit patterns to provide time stamp encoding. Time aware networks employing new hardware may choose to encode the time stamps in a sideband modulation, because sideband modulation provides a per packet time stamp without sacrificing transport bandwidth.

d. Locking Authorities:

Locking assures synchronization and coherency of transactions with a shared resource by giving one client exclusive access to the resource for a specified period of time. Optimally, the exclusivity given to a single client is for a short time period thus providing each client with the appearance of having exclusive and continuous access to the shared resource. The locking function provides each client with the assurance that, during the time it has access to the shared resource, the state of the resource is under the exclusive control of that client.

As illustrated in FIG. 1, the time aware network 101 further includes a locking authority 111. The locking authority 111 is configured to serialize and synchronize the client's 103 access to the shared resource 109. A shared resource 109 may be any component or device accessible by one or more client. For example, FIG. 1 depicts a multitude of shared resources 109 which includes, but is not limited to, mass storage mechanisms such as disk arrays and databases, mass memory systems and streaming media (video and sound) systems. It is important to realize that the locking authority 111 is also a time aware device. The locking authority and its respective locking scenarios, which allow access to the shared resource while maintaining data integrity, is discussed below in further detail.

In summary, the time aware network 101 shown in FIG. 1 uses absolute time values associated with each network element (that is, clients 103, router 105, locking authority 111 and the shared resource 109) to create a time reference equivalent to a computer clock, thereby eliminating the need to synchronize time information between the network elements. As such, when a client 103 transmits a packet over the network transport 107, the packet arrives at the time aware router 105 having a time stamp showing the transmission time. The time aware router forwards the packet over the network 101 to a locking authority 111. The locking authority 111 prioritizes the received packets using the transmission time based time stamp. Upon establishing an exact order, the locking authority 111 grants a single client 103 access to the shared resource 109.

Synchronization without a network clock and without exchanging time information between devices is accomplished upon the creation of a network clock domain. As described in detail below, a network clock domain is established using a set of parameters that defines how each time aware device utilizes its absolute time value for purposes of communicating and accessing resources in the network clock domain.

IV. Network Clock Domains

Within the time aware network, the locking authority is responsible for creating network clock domains and initializing network clock domains. Furthermore, the locking authority uses the network clock domain to control access to shared resources on the network. Advantageously, the locking authority may create and control multiple network domains.

Conventional locking authorities simply regulated access to a shared resource based on the first packet to be received and thus lacked the ability to determine which packet was transmitted first. This resulted in client requests being processed out of order. In contrast, the locking authority described herein is configured to examine packet time stamps received from various time aware clients on the time aware network. The locking authority reorders packets based on the packet's transmission time stamp and upon the availability of buffer memory in the locking authority. The packet with the earliest transmission time stamp is then delivered to the shared resource. The present locking authority also flags packets that are received out of order.

Before a locking authority provides locking services between clients and shared resources, the locking authority creates a network clock domain. It should be noted that a locking authority may create and support multiple network clock domains in order to handle clients with different capabilities. For example, some clients may not be capable of the time precision required for a high performance network clock domain. The same client may nevertheless be able to participate in a network clock domain having minimal accuracy and latency requirements. Additionally, clients may utilize different methods for responding to and reordering packets received out of sequence by the locking authority. It is therefore desirable to group all clients with similar capabilities into network clock domains that match those client capabilities. In short, the network clock domain is a timing protocol based on the timing requirements of the shared resource, wherein all devices (including but not limited to the router, locking authority and client) must be capable of meeting the timing requirements set forth by the timing protocol in order to interact with each other and with the shared resource.

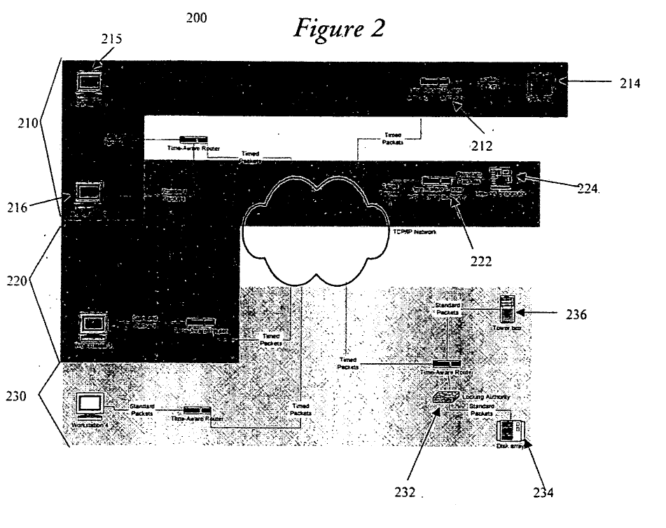

The interrelationship between the time aware devices on the time aware network including the locking authority, shared resources, clients and the network clock domain is best described with reference to FIG. 2. FIG. 2 depicts a time aware network 200 employing three individual network clock domains 210, 220 and 230. Each network clock domain 210,220,230 provides synchronized access to shared network resources including disk arrays 214,234, a network processor 224 and a tower box 236. The time aware network 200 further includes at least one locking authority per network clock domain. As depicted in FIG. 2, locking authority 212 creates and maintains network clock domain 210. Similarly, network clock domains 220 and 230 are respectively maintained by locking authorities 222/232. It is important to note that the locking authority may be incorporated with the time aware router as illustrated in the network clock domain 210,220. Alternatively, the locking authority may exist external to the time aware router as shown in network clock domain 230.

As further illustrated in FIG. 2, each locking authority is associated with at least one shared resource. For example, the locking authority 212, in network clock domain 210, controls access to the disk array 214. On the other hand, the locking authority 232, which maintains the network clock domain 230, controls access to two shared resources, namely the tower box 236 and the disk array 234.

Each locking authority 212,222,232 is responsible for maintaining at least one established network domain 210,220,230. Clients join the network clock domains in order to access the shared resource (i.e. the disk arrays 214, 234, the network processor 224 and the tower box 236) being controlled by the locking authorities. Locking authorities may establish more than one network clock domain, but only one network clock domain per locking authority is shown in FIG. 2 for simplicity.

As further depicted in FIG. 2, network clock domain 210 has two clients 215, 216 currently participating in the domain. Similarly, network clock domain 220 also has two clients 216, 226 participating in the domain. Clearly, a single client may participate in multiple network clock domains as illustrated by client 216 who is currently utilizing two network clock domains 210,220.

a. Initializing Network Clock Domains

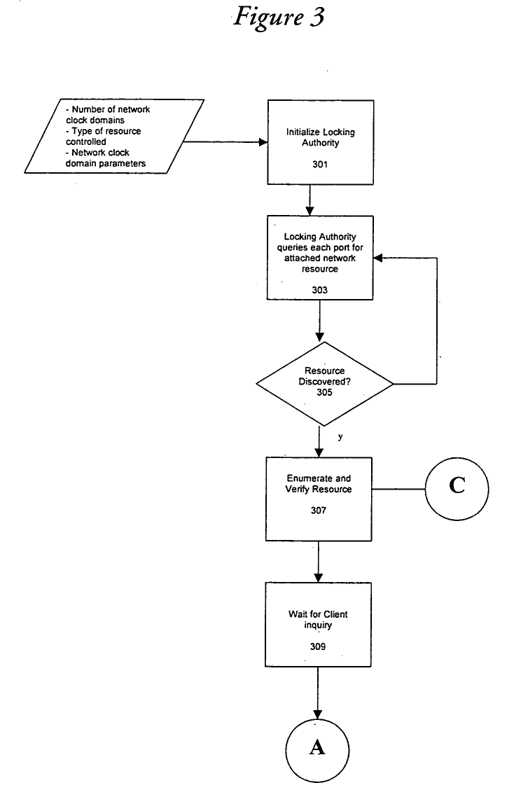

Simply put, during the initialization of the network clock domain, the locking authority must determine how many network resources are attached to the locking authority, the type of resource attached and the capabilities of these network resources with respect to transaction locking. FIG. 3 is a flowchart that depicts the dynamic process implemented by the locking authority to initialize a network clock domain.

The process starts with initialization of the locking authority itself. In step 301, the locking authority accepts the configuration parameters provided by the network administrator. These parameters include, but are not limited to, the number of clock domains supported, the type of resource controlled, and the characteristics and capabilities of each supported network clock domain.

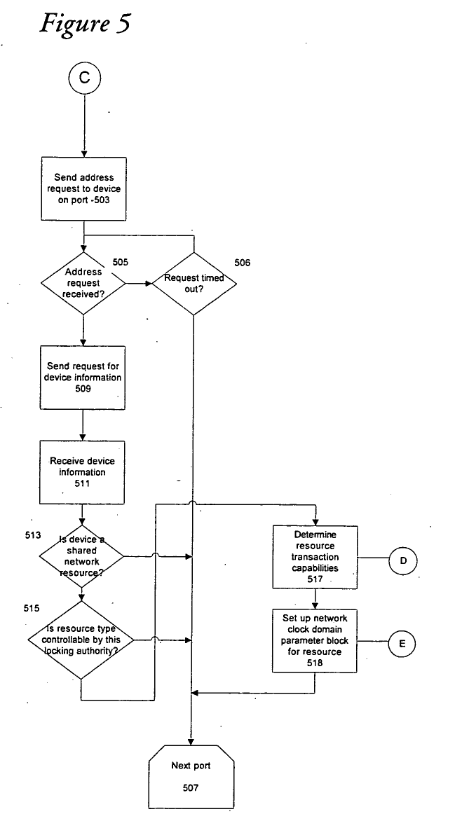

Once locking authority initialization 301 is complete, the locking authority loops over and queries its ports to identify attached network resources as shown in step 303. In step 305, a determination is made as to whether an attached network resource has been discovered. As discussed in greater detail with respect to FIG. 5, step 307 discloses that upon the successful identification of a network resource, the network resource is enumerated and verified. If, on the other hand, an attached network resource is not discovered, the process returns to step 303 thereby allowing the locking authority to continue querying ports for possible attached network resources. Upon completion of step 307, the locking authority is placed in an idle state waiting for a client inquiry as shown in step 309.

FIG. 5 is a flowchart illustrating the enumeration and verification process performed upon the locking authority's identification of an attached network resource (see step 307 in FIG. 3). In step 503, the locking authority sends ar address request to the identified network resource attached to the port. The form of this request is dependent on the type of underlying network. For example, in a TCP/IP network, the locking authority may send an ARP (Address Resolution Protocol) message to device. A determination is then made concerning receipt of the requested address as shown in step 505. If a predetermined amount of time passes before the locking authority receives the requested address, the request times out as depicted in step 506. The locking authority then exits the enumeration and verification process and the moves on to the next port as shown in step 507. If, however, the requested address is received from the attached network resource, then the locking authority uses the received address to send an additional information request to the network resource as shown in step 509.

Continuing on with respect to FIG. 5, the attached network resource receives the additional information request in step 511. In step 513, a determination is made concerning whether the attached network resource is a shared network resource as opposed to a client, server or dedicated resource. If the attached network resource is a shared network resource, the process continues to step 515 to determine whether the network resource type is controllable by the locking authority. If the attached device is a shared resource and if the attached device is a resource controllable by the locking authority, then the process proceeds to step 517. If a negative determination is made with respect to steps 513 and 515, the process exits the enumeration and verification procedure and moves on to the next port as shown in step 507.

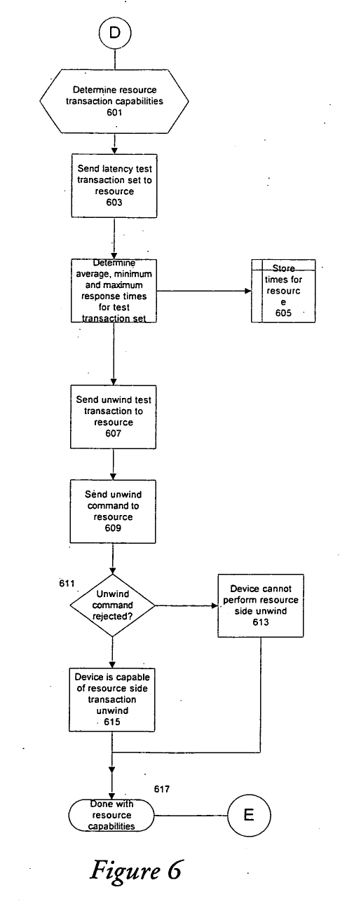

Referring back to step 517, upon the determination that the attached network resource is shared and controllable by the locking authority, the locking authority evaluates the attached network resource's transaction capabilities. The evaluation of the attached network resource's capabilities is discussed in conjunction with FIG. 6. Using the information acquired through the enumeration and verification process and through the network resource capability determination process, the locking authority establishes a network clock domain parameter block for the network resource as illustrated by step 519. The importance and utilization of the clock parameter block is discussed below in further detail.

Turning now to FIG. 6, a flow chart illustrating the process for determining the transaction capabilities of a network resource is provided. In step 601, the locking authority sends a set of test transactions to determine the transaction response time capabilities of the resource. The test transactions may be dependent on the type of network resource. For example, for a storage network resource, the test may be an inquiry data command, read capacity command, followed by a test unit ready command. A set of read and write commands may follow. Upon completion of the tests and in step 603, the locking authority determines the average, minimum and maximum response time for the network device in response to these test transaction or commands. The number of commands used to test the response time may be configurable by the system administrator, but would normally be in the range of 100 transactions. This provides a statistical average without unduly delaying the initialization process. As shown in step 605, the transaction response time capabilities for the network resource are stored in memory.

Once the transaction response time capabilities of the resource have been determined, the locking authority sends an unwind test transaction to the network resource as shown in step 607. The unwind test transaction determines if the network resource is capable of performing an unwind the transaction. Once the network resource completes the unwind test transaction, the locking authority sends a transaction unwind command to the network resource as depicted in step 609. If the network resource rejects the unwind command in step 611, it is determined that the network resource is not capable of performing a resource side transaction unwind (see step 613). Upon determining that the network resource is incapable of performing the resource unwind as shown in step 613, the locking authority exits the resource transactions capability process in step 617 thereby forcing the locking authority to use a client side unwind for all transactions. If, on the other hand, the network resource accepts the unwind command and properly unwinds the test transaction as illustrated in step 615, the locking authority will use resource side unwind processing to reorder client locking requests. Whether the determination of the resource transaction capabilities is positive or negative, the process nevertheless exits as shown in step 617 and returns to step 519 wherein a Network clock parameter block is established for the resource as depicted and described with respect to FIG. 5.

b. Clock Parameter Blocks and the Network Clock Domain

The clock parameter block is instrumental in creating and joining the network clock domain because the clock parameter block defines the requirements that the client must satisfy in order to participate in the network clock domain. As such, the parameters in essence define the requirements of the network resource which enable the client and network resource to communicate using the absolute time values. Examples of the parameters set forth in the clock parameter block include, but are not limited to, minimum clock accuracy, minimum clock precision, clock value (typically in nanoseconds), the number of clock phases and a clock time start value.

The parameters in the clock parameter block further define how the client will generate an internal “pseudo-clock” for use in the timing of network communications. The locking authority which established the network clock domain generates an identical pseudo-clock so that the client and the locking authority may execute time synchronized operations without the need to provide a master clock source or exchange actual clock information or signals.

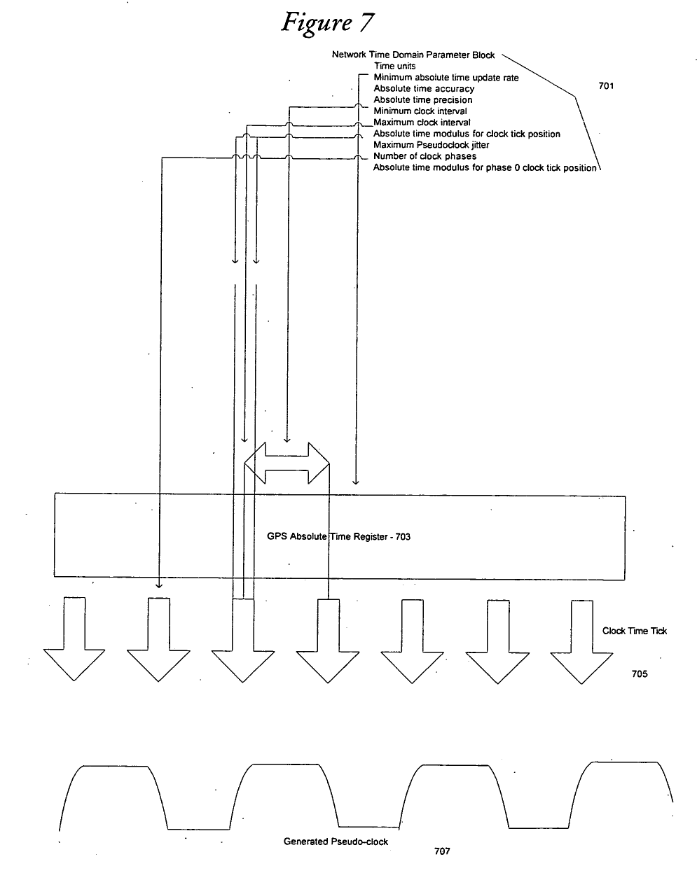

FIG. 7 illustrates the method for generating the pseudo-clock using network clock domain parameters and absolute time values. Specifically, the network clock domain parameter block 701 defines clock units (e.g. nanoseconds, picoseconds) for all times provided in the clock parameter block. In other words, the first parameter in the clock parameter block defines the time units used for the other parameters in the clock parameter block. The clock parameter block contains a minimum accuracy and precision value for absolute time value that the client must guarantee using its internal GPS time recovery circuitry. If the client cannot guarantee these values, it may not join the network clock domain.

The client updates the time value stored in the GPS absolute time register 703 at a rate equal to or greater than the minimum absolute time update rate set forth in the clock parameter block 701. Each time this value is updated, it is compared to the clock tick modulus and the phase 0 clock tick modulus (if the clock has more than one phase). If the modulus value is less than the absolute time precision in the clock parameter block 701, a clock time tick 705 is generated. The time tick 705 is used to define the next edge for the pseudo-clock. As such, the series of time ticks 705 generates one or more phases of the pseudo-clock 707 that meets the required accuracy and precision specifications. The generated pseudo-clock 707 is monitored to ensure that it is being generated with a jitter less than the maximum jitter specified in the clock parameter block 701. Monitoring the jitter of the generated pseudo-clock 707 ensures that the pseudo-clock continues to provide the required accuracy and precision to make use of the locking authority.

c. Joining Network Clock Domains

A client may join a network clock domain dynamically or through the use of a priori knowledge. A client dynamically joins a network clock domain by sending a request to the locking authority to find out what capabilities and configurations are required in order to join the network clock domain. In other words, the client asks locking authority for a clock parameter block. The clock parameter block is sent from the locking authority to the client.

If the client is capable of meeting the requirements set for the in the clock parameter block, then the client transmits a confirmation message to the locking authority. Upon transmission of the confirmation message, the client is considered to have joined the network clock domain. Once a client joins the network clock domain, the client may obtain locks and exclusive access to the network resource controlled by the locking authority.

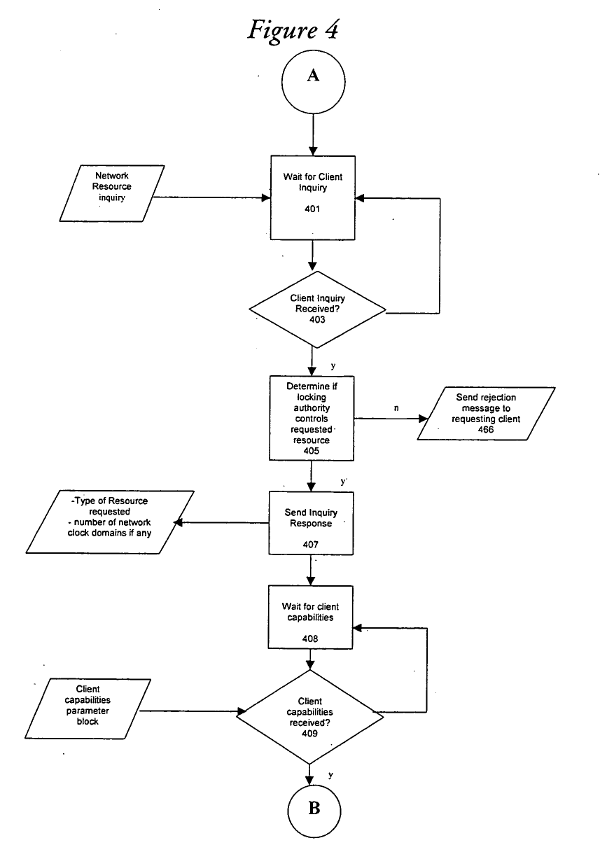

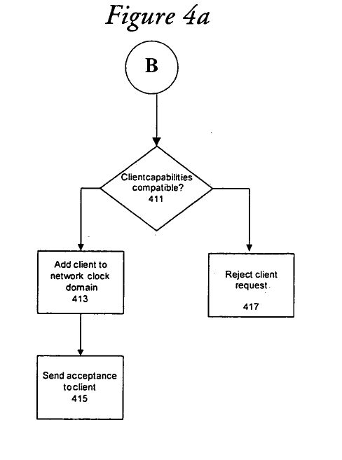

More specifically, FIGS. 4 and 4a are flowcharts illustrating the process of a client joining the network clock domain initialized in FIG. 3. Specifically, the addition of a client to the network clock domain is initiated by the client. The client begins the process of joining a network clock domain by sending a network resource inquiry message to the waiting locking authority as shown in step 401. A determination is made in step 403 concerning whether the client inquiry has been received. If the request is not received, the process returns the locking authority to its idol state represented by step 401. If, on the other hand, the client's inquiry is successfully received, then the locking authority determines in step 405 if it controls a resource of the type requested as depicted in step 403. If the locking authority does not control the requested resource, a rejection message is transmitted to the requesting client in step 406. Alternatively, if the locking authority does control the requested resource, the process continues to step 407 wherein the locking authority responds to the client's message with an inquiry response message. The inquiry response message includes a request that the client send a clock parameter block describing the network clock domain parameters the client is capable of supporting.

In step 409, the locking authority receives a response to the inquiry response message which describes the client's capabilities. If the locking authority does not receive a response from the client, the locking authority maintains a waiting state as shown in step 408. In step 411, the locking authority compares the client's capabilities to the network clock domain'requirements. If the client's capabilities are within an acceptable range of the requirements necessary for the network clock domain, the client is allowed to join the network clock domain as illustrated in step 413. Upon being admitted into the network clock domain and in step 415, a confirmation message is transmitted to the client thus allowing the client to request access to the shared resource also participating in the network clock domain. If, on the other hand, the client's capabilities do not match the requirements set forth by the network clock domain, the client's request to join the domain is rejected as shown in step 417.

Upon joining the network clock domain, the client may request access to the shared resource and participate in the locking schemes described below. Meanwhile, the locking authority continues to wait for other clients to request access to the controlled resource wherein the process described with respect to FIG. 4 is repeated.

General principles of the network domain apply to all clients. For example, the time at which a client joins or leaves a network clock domain does not affect the operation of the network clock domain. Additionally, nothing is required of the client to leave a domain. If multiple clients desire to join the domain, the locking authority will place the received packet requests in order as determined by the packet's transmission time stamp. Importantly, a time aware device, or client, may participate in multiple network clock domains however, a shared resource may only participate in a single network clock domain.

As briefly mentioned above, a client may also become a member of the network clock domain through a priori knowledge. If a client is a member through a priori knowledge, the knowledge required to join the domain is simply provided by the system or network administrator upon configuring the locking authority.

V. The Locking Authority

Once a client has successfully joined a network clock domain, the client may begin requesting access to the shared resource via the locking authority. The locking authority is an essential means for ensuring that serialize and synchronize resource access is provided to each client. The locking function further maintains the coherency of the shared resource's data by ensuring that packet requests are processed in the proper sequence according to transmission time stamp associated with the packet.

a. Locking Authority Description

A locking authority may be realized in numerous different physically forms. For example, a locking authority may be incorporated into a network resource such as a storage device. It may also be incorporated into a time-aware router or may exist as a separate and independent physical unit on the time aware network.

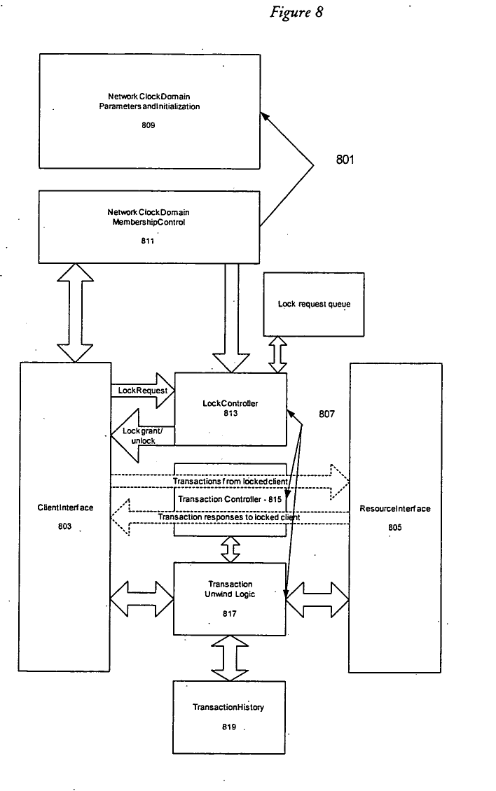

FIG. 8 illustrates the logical structure of the locking authority. As shown, the locking authority consists of four major logic blocks: the network clock domain logic 801; the client interface logic 803; the resource interface logic 805; and the transaction control logic 807.

1. Network Clock Domain Logic

The network clock domain logic 801 performs of two major functions, namely, the domain parameter control function 809 and the domain membership control function 811. The first function, or the domain parameter control function 809, establishes the network clock domain parameters appropriate to the resource and the network capabilities. Furthermore, the domain parameter control function 809 may be configured to establish multiple network clock domains. The primary reason for establishing multiple network clock domains is to allow clients with different capabilities to access the shared resource. For example, some clients may be capable of higher accuracy or precision in timing while others may use the polling method to obtain a time slot in which a lock request may be made. As such, the domain parameter control function 809 determines the types of locking methods that are supported by the network clock domain in addition to the required capabilities for clients attempting to join the network clock domain.

The second function in the network clock domain logic 801 is the domain membership control function 811. This function responds to client requests for network clock domain parameters and receives requests from clients to join the network clock domain. The function contains logic to ensure that any client attempting to join the domain has the requisite capabilities to participate.

2. Client Interface Logic

The client interface logic 803 acts as an interface to the time-aware network. The client interface logic 803 contains the logic necessary to examine and compare time stamps as packets arrive from the various clients on the network. The client interface logic also obtains from each client the client's transaction unwind capabilities.

3. Resource Interface Logic

The resource interface logic 805 provides a specialized interface to the resource being controlled. The resource interface is particular to the type of resource being accessed. Furthermore, the resource interface logic also determines the transaction queuing and unwind capabilities of the shared resource.

4. Transaction Control Logic

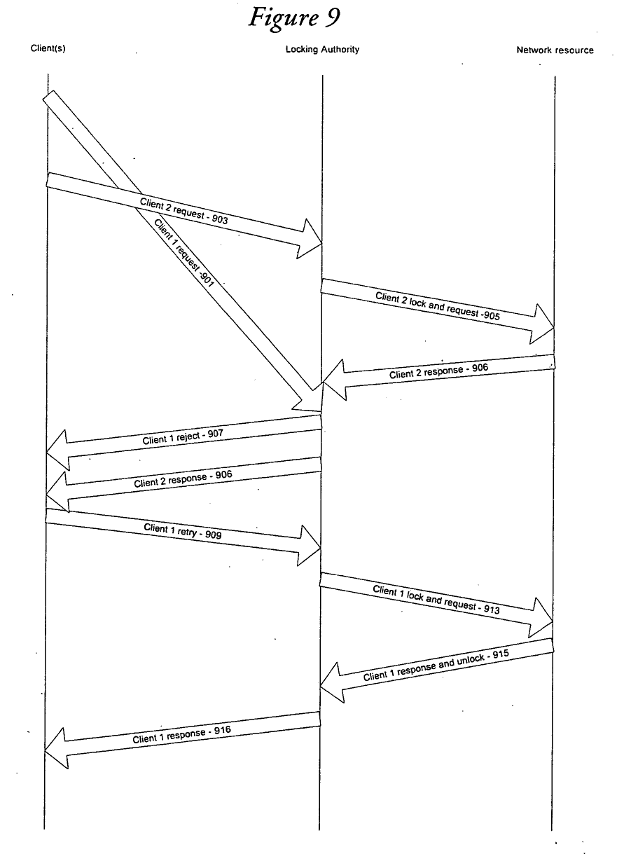

The transaction control logic 807 consists of three major functions: the lock control function 813; the transaction control function 815; and the transaction unwind function 817. Working together, these three functions implement the logic for the various locking scenario ladder diagrams shown in FIGS. 9-12 and discussed below in detail.

The lock control function 813 obtains the list of clients participating in the network clock domain from the clock domain membership control function 811. The lock control function 813 also obtains the order of arrival of lock request packets from the client interface function 803. Using this information, the lock control function grants, denies or queues a client's lock request, depending on the current state of the resource and the capabilities of the client.

The transaction control function 815 connects transaction requests and responses from the clients to the shared resource. Additionally, the transaction control function 815 establishes a data pathway from the shared resource back to the client currently holding a lock for the shared resource. Depending on the capabilities of the shared resource and the specific implementation of the locking authority, the transaction control function 815 further maintains a transaction history 819 for the duration of a lock. This transaction history 815 may be used by the transaction unwind controller 817 to unwind transactions if a resource of client is capable of unwind. The transaction history 819 may also be provided to other clients that are denied or deferred locks in order for the client to preserve data and transaction state coherency.

c. Locking scenarios

The ability to reconstruct and preserve the transmission order of incoming packets sent from time aware devices is key to maintaining data coherency in scale free networks. Sequencing packets provides both clients and servers with appropriate information about order for both data sequences in addition to control and status messages. This allows a receiver of multiple packets from multiple sources, such as the locking authority, to sort the packets based on the order of transmission and act on the received commands accordingly. This concept of sequencing, ordering and sorting packets is put into effect using a numerous locking scenarios as described in detail below. It is important to note that the locking scenarios may involve multiple clients, however, the exemplary embodiments described below are limited to two clients for simplicity.

The locking scenarios described below involve two clients, the locking authority and the shared resource, all of who are members of a network time domain set up by the locking authority. Time ladder diagrams are used to illustrate the sequence and dependencies of the transactions and communications between the clients on the left, the locking authority in the middle and the network resource on the right.

Each locking scenario depicts a different method used by the client and the locking authority to grant a lock to one client and reorder the request from another client for the same lock when the client requests are received out of order. In these exemplary locking scenarios, the lock requests are for exclusive access to the shared resource. An example of such a request may be a read/write lock. Some lock requests need not be exclusive, such as read-only locks. Multiple read-only locks may be granted to clients simultaneously. Thus, locking issues arise when a client requests an exclusive lock such as the read/write lock. If a read/write lock request is sent after a read lock is granted, the read/write lock may be held as a pending request until the read lock is released. Furthermore, the term response as depicted in the ladder diagrams refers to the data or transaction information requested by the client. Generally, once the response is complete, the lock on the network resource is automatically released.

1. Basic Out of Order Reject

As illustrated in FIG. 8, the transaction control function connects transaction requests and responses from the clients. FIG. 9, however, is a diagram illustrating a basic out of order reject locking scenario. More specifically, FIG. 9 illustrates how a locking authority uses a reject of a lock request from a client to re-queue the client's request and ensure that data coherency is maintained.

As shown, client 1 first issues a lock request 901 for the shared resource to the locking authority. Subsequently, client 2 also issues a lock request 903 for the same shared resource.

Typically, client 1 would receive a lock and perform its transaction. The request 903 from client 2 would be queued by the locking authority and granted as soon as the lock held by client 1 was released. Client 2 might or might not suspend operation pending grant of the lock depending on whether the request was a blocking or a non-blocking request.

However, in the present scenario, the locking authority receives the request 903 from client 2 before it receives the locking request 901 transmitted by client 1. The delay of client 1's request 901 may be cause by number of factors such as network transport delays. In short, the locking authority received the requests out of order. At this juncture, the locking authority does not know that client 1 had issued a previous lock request, the locking authority therefore grants the lock 905 on the shared network resource to client 2.

When the lock request 901 from client 1 arrives, the locking authority determines from the absolute time stamp in the request packet, that the request 901 was issued first and has arrived out of order. The locking authority cannot determine whether or not to grant the request since it does not have information about the transactions for clients 1 and 2 associated with their requests.

The transaction request 903 is therefore completed as evidenced by the response 906 sent from the network resource to the locking authority and from the locking authority's response 908 sent to client 2. The locking authority deals with this ambiguity by rejecting 907 the request 901 from client 1. Client 1 is thus informed that the locking authority did not grant the request 907.

In this particular configuration, client 1 is not provided information about the reason for the rejection beyond the fact that the request was received out or order. Client 1 thus re-queues a new request 909, with a new time stamp, and issues the new request 909 to the locking authority. Since the request is now ordered after the request 903 from client 2, the locking authority holds pending the request 909 until client 2 has completed its transaction and released the lock (see response messages 906). At that time, the lock request 909 from client 1 is granted 913, thus preserving the coherency of the data at the resource and the coherency of the transactions executed by both client 1 and client 2. Upon completing its transaction, client 1 releases the lock on the shared resource 915. Additionally, a response 917 is transmitted from the locking authority to client 1 confirming that the lock's release as a result of completing the transaction.

2. Basic Reorderine With Resource Unwind

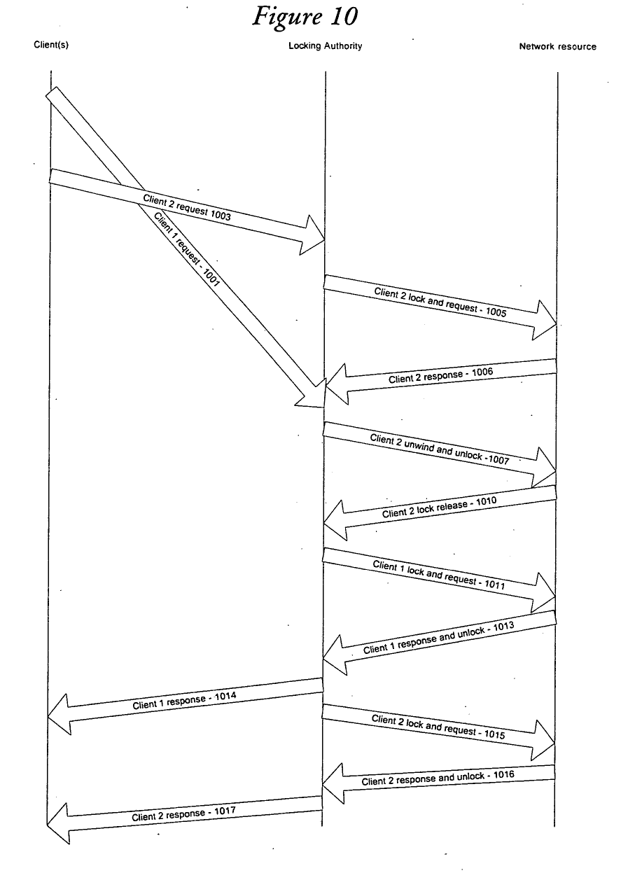

FIG. 10 is a diagram illustrating how the locking authority reorders lock requests and transactions when a request is received out of order. In this given locking scenario, the shared resource being locked is capable of unwinding a transaction in order to preserve data coherency. The unwind capability, however, may be contingent on how much time has passed since the transaction was completed or on the size and content of the transaction.

In some resource unwind and reorder cases, the shared resource may reject the unwind request. In such situations, the locking authority will revert to using a basic reject of the out of order lock request as described with respect to FIG. 9.

Looking now at FIG. 10, client 1 issues a lock request 1001. Subsequently, client 2 also issues a lock request 1003. Because the locking authority receives request 1003 first, the locking authority grant 1005 client 2's lock request 1003. However, due to network delays and latency, the request 1001 from client 1 is received after the request 1003 from client 2. The locking authority uses the transmission based time stamp in the client 1 lock request 1001 to determine that the request 1001 has been received out of order.

As such, the locking authority suspends processing of commands and transactions from client 2. It then sends an unwind request 1007 to the shared resource. The shared resource will unwind all transactions and commands associated with client 2 since the lock 1005 was granted. Once the locking authority unwinds the transaction 1007, client 2's lock on the network resource is released 1010. If unwinding is not possible, due either to the amount of time or the nature of the transaction, the resource will reject the unwind request (not illustrated).

Assuming that the unwind request 1007 is successful, the locking authority will re-queue client's 2 lock request and all transactions associated with client 2. The locking authority then grants a lock 1011 to client 1 and allows client 1 to proceed with its commands and transaction. Once completion of the transactions, the lock on the network resource is released 1013 and the locking authority informs client 1 of the completed transaction 1014. The resource, however, will again be locked 1015 to client 2 and the client 2 transaction will proceed. Upon completion of client 2's transactions, the lock on the network resource is released 1016 and the locking authority informs client 2 1017 of the completed transaction.

The advantage of this procedure is that the unwind and re-grant is transparent to client 2. Client 2 is only aware that it took a longer time period to satisfy the client 2's transaction than is normally expected. However, there was no additional action or response required from client 2 in order to service its transaction in a manner that preserves data coherency and integrity.

3. Reordering Using Client Unwind

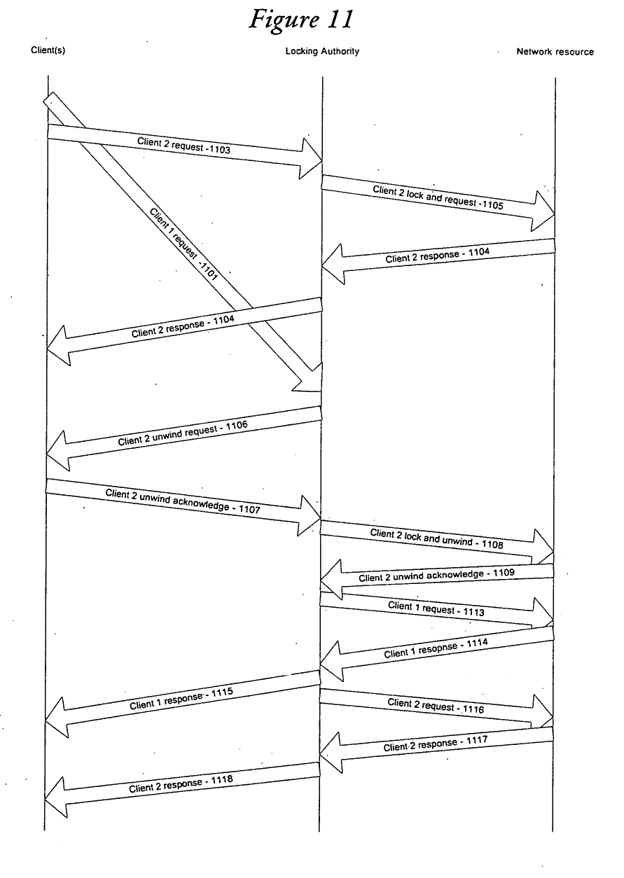

FIG. 11 shows how a locking authority reorders requests received out of order where a client is capable of unwinding a transaction already in progress. In this particular locking scenario, Client 1 sends a lock request 1101 to the locking authority controlling a network resource. Subsequently, Client 2 sends a lock request 1103 for the same resource. Due to network delays and latency, the locking authority receives the lock request 1103 from Client 2 first and grants the lock request 1105. When the lock request 1101 from Client 1 arrives, the locking authority determines that the request 1101 was received out of order by examining the transmission based time stamp contained in the packet transporting the lock request 1101 from Client 1. Moreover, client 2's request has been completed as evidence by the response from the network resource to the locking authority and then to client 2 1104.

Because a response 1104 has been received by client 2 prior to the receipt of client 1's request 1101, a client side unwind may be performed. At the time the network clock domain was configured, Client 2 indicated that it was capable of unwinding transactions in progress. Thus, the locking authority suspends the Client 2 transaction and sends an unwind request 1106 to Client 2. Client 2 accepts the request 1107 and the locking authority unwinds the transaction 1108. The network resource then acknowledge the unwind transaction by sending a message 1109 to the locking authority.

The locking authority then grants Client 1's lock request and proceeds with the Client 1 transaction 1113. Upon completion, the lock is released 1114 and client 1 is informed by the locking authority that the transaction complete 1115. The locking authority then grants a lock 1116 to Client 2 and proceeds to execute Client 2's transaction. Similarly, the lock is ultimately released 1117 and client 2 is informed by the locking authority that the transaction is complete 1118.

The advantage to using a client unwind is that the client retains complete control over the manner in which the transaction is unwound. Additionally, the client may decide to modify or delete the transaction based on the unwind and additional activity from Client 1. The disadvantage is that more network traffic is required and the client is required to have more sophisticated software and transaction maintenance.

4. Rejection of Client Unwind Request

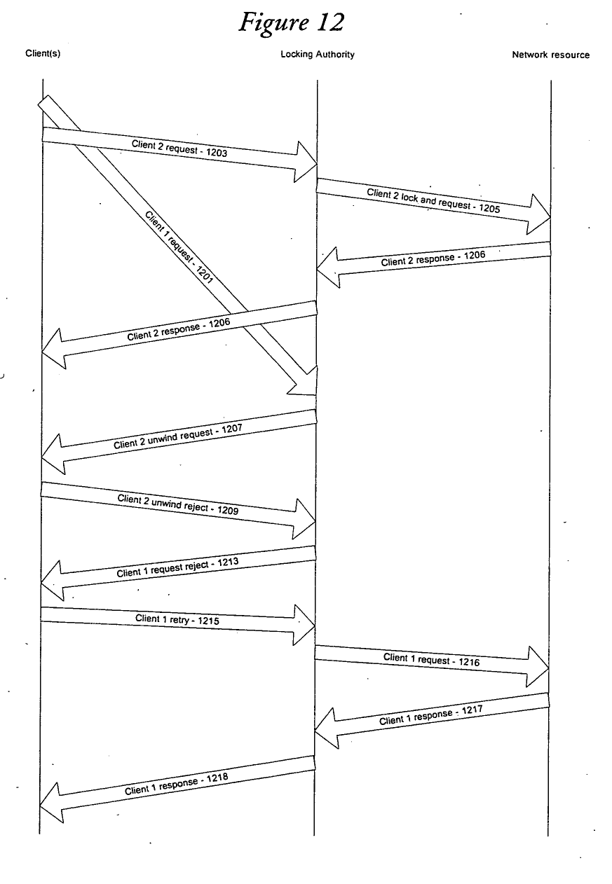

FIG. 12 is a diagram depicting a locking scenario wherein a client's unwind request is rejected. More specifically, FIG. 12 describes the sequence of events experienced when a client rejects an unwind request from the locking authority.

As before, Client 1 sends a lock request 1201 and subsequently client 2 sends a lock request 1203. The lock request 1203 from Client 2 is received first and a lock is granted 1205 by the locking authority. When the request 1201 from Client 1 arrives, the locking authority determines that it was received out of order by examining the transmission time stamp in the packet transporting the lock request from Client 1. However, as indicated by response message 1204, a response has already been sent to client 2 before the locking authority received the request 1201 from client 1. As a result, the locking authority must attempt to unwind the transaction with respect to client 2, essentially asking client 2 to ignore the response message 1206 sent from the locking authority.

In this case, Client 2 has previously indicated that it is capable of unwinding transactions in order to preserve order and coherency. Thus, the locking authority suspends client 2's transaction and sends Client 2 an unwind request 1206. However, in this case, Client 2 cannot unwind the transaction for one reason or another. It may be that too much time has elapsed or that Client 2 has used the results of the transaction for other processing and cannot guarantee coherency of the unwound transaction and data. Client 2 thus sends the locking authority an unwind rejection 1209. The locking authority then continues Client 2's transactions and sends Client 1 a lock reject 1213 thereby forcing client 1 to re-queue its request 1215.

Once Client 2's transaction is complete and the lock is released 1214, Client 1 sends a new lock request 1215 with a later time stamp to the locking authority. Because this request 1215 is not out of order, it is granted 1216 once Client 2's transaction is complete. Upon completion, the lock is released 1217 and the locking authority informs client 1 of the transaction's completion 1218.

d. Handling Locking Errors

Time aware networks and their associated network clock domains provide robust and simple handling of various locking errors that occur on the network. Unfortunately, error conditions occur due to a number of circumstances. For example, error conditions may occur because packets are lost or excessively delayed on the network. The worst case is the loss of a packet, since a delayed packet will ultimately arrive and allow the unraveling of the deadlock condition that may have been created. However, when a packet is lost, the transmitting device has no way of verifying loss, except through long timeout periods and thus no way to know that the packet was not received.

Another example of an error condition circumstance occurs when a client requesting or holding a lock crashes or experience some other type of catastrophic operational error. The locking authority and locked resource have no way of knowing the client is no longer operating properly. If the client is holding or requesting a lock at the time, the lock must be released and any further or pending requests from the client must be rejected, otherwise a deadlock situation results. Similarly, the resource or locking authority may experience some catastrophic operational error. Clients with pending locks have no way of being notified of the situation thus resulting in a deadlock.

Proper management of time between the clients and the locking authority is a solution to the above-described circumstances. All lock requests and lock grants are performed using specified timeout values. Since the timeout values are based on absolute time using the parameters of the network clock domain to interpret the absolute time values, the timeouts may be as short as possible given the inherent transmission delays and latencies in the network. There is no scenario in which a lock may be either requested or granted and then abandoned such that the system is not capable of detecting and correcting the abandonment and recovering normal operations.

1. A time aware network, comprising:
a plurality of time aware devices, each of the plurality of time aware devices having an absolute time value, wherein an inherent time reference is created when the absolute time value associated with each time aware device satisfies defined timing parameters thereby eliminating the need to synchronize time information among the plurality of time aware devices.

2. The time aware network of claim 1, wherein the inherent time reference is utilized in any communication system that requires strict sequencing of transmitted and received messages.

3. The time aware network of claim 1, wherein the plurality of time aware devices are configured to communicate in synchronous fashion using the inherent time reference.

4. The time aware network of claim 1, wherein the absolute time value for each of the plurality of time aware devices is a time coordinate extracted from a GPS signal.

5. The time aware network of claim 1, wherein the time aware device is a client device.

6. The time aware network of claim 5, wherein the client device is any one of a workstation, a server, a CPU, or a wireless device.

7. The time aware network of claim 1, wherein the time aware device is a locking authority.

8. The time aware network of claim 1, wherein the time aware device is a shared network resource.

9. The time aware network of claim 1, wherein the time aware device is a router.

10. The time aware network of claim 1, wherein the defined timing parameter is a clock parameter block, said clock parameter block configured to set forth the requirements that each of the plurality of time aware devices must be capable of satisfying in order to communicate with other time aware devices using the inherent time reference.

11. The time aware network of claim 7, wherein the locking authority creates a network clock domain.

12. The time aware network of claim 11, wherein said network clock domain is established using the clock parameter block.

13. The time aware network of claim 11, wherein the clock parameter block is based on the timing requirements of the shared resource.

14. The time aware network of claim 11, wherein the client joins a network clock domain to access the shared resource.

15. The time aware network of claim 14, wherein the locking authority controls the client's access to the shared resource.

16. The time aware network of claim 15, wherein the locking authority provides data coherency by controlling access to the shared resource.

17. The time aware network of claim 15, wherein the locking authority uses a plurality of locking scenarios to control access to the shared resource.

18. The time aware network of claim 16, wherein the locking authority is configured to reorder received messages based on a transmission time stamp.

19. The time aware network of claim 17, wherein the locking authority is further configured to grant a lock to a first client and re-queue a request received from a second client.

20. The time aware network of claim 8, wherein the shared resource is a network resource.

21. The time aware network of claim 8, wherein the shared resource is a mass storage mechanism.

22. The time aware network of claim 21, wherein the mass storage mechanism is a database.

23. The time aware network of claim 21, wherein the mass storage mechanism is a disk array.

24. The time aware network of claim 20, wherein the shared resource is a mass memory system.

25. The time aware network of claim 20, wherein the shared resource is a streaming media system.

26. The time aware network of claim 1, wherein the inherent time reference is a pseudo-clock generated by the locking authority using the clock parameter block and the absolute time values

27. The time aware network of claim 11, wherein in order to communicate using the inherent time reference, the time aware devices and the shared resource belong to the same network clock domain.

28. The time aware network of claim 11, wherein clients must join the network clock domain in order to access the shared resource in the network clock domain.

29. The time aware network of claim 2, wherein the resequencing of the received messages is based on a time stamp indicating the time the message was transmitted.

30. An inherent network time reference, comprising:
an absolute time value, said absolute time value being a time coordinate extracted from a GPS signal;
a parameter block, said parameter block defining the timing requirements,
wherein when the absolute time value satisfies the timing requirements defined by the parameter block the inherent network time reference is established enabling devices with the absolute time value to communicate without synchronizing time information.

31. The inherent network time reference of claim 30, wherein the inherent time reference is utilized in any communication system that requires strict sequencing of transmitted and received messages.

32. The inherent network time reference of claim 30, wherein the device is a time aware device.

33. The inherent network time reference of claim 30, wherein the inherent network time reference acts as a pseudo-clock for a time aware device.

34. The inherent network time reference of claim 32, wherein the time aware device includes a GPS receiver for extracting the timing coordinate.

35. The inherent network time reference of claim 32, wherein the timing requirements are set forth by a shared resource.
